(19) United States
(12) Patent Application Publication
(10) Pub. No.: US 2026/0367873 A1
(43) Pub. Date: Nov. 19, 2026

(54) METHOD AND SYSTEM FOR GENERATING A SOFTWARE DEVELOPMENT FRAMEWORK WITH AT LEAST ONE HIERARCHICAL DATA POLICY CONTROL ON AN INFRASTRUCTURE PROVISIONING TRANSACTION

(71) Applicant: JPMorgan Chase Bank, N.A., New York, NY (US)

(72) Inventors: Srikanth JAGROTHU, Hyderabad (IN); Venkatesh KINTHALI, Bengaluru (IN); Ian Mark MILLER, London (GB); Darren MARVIN, Poole (GB)

(73) Assignee: JPMorgan Chase Bank, N.A., New York, NY (US)

(21) Appl. No.: 19/285,570

(22) Filed: Jul. 30, 2025

(30) Foreign Application Priority Data
May 19, 2025 (IN) 202511047973

(51) Int. Cl. G06F 8/20; G06F 11/3604

(52) U.S. Cl. CPC G06F 8/20; G06F 11/3604

(57) ABSTRACT

A method and system for generating a software development framework with at least one hierarchical data policy control on an infrastructure provisioning transaction. The method includes receiving a data request comprising an infrastructure provisioning transaction request and developing a data policy correlating to a hierarchical data layer based on the data request. The method also includes performing a local validation testing and performing an impact analysis process of the data policy, and generating a software development framework with at least one hierarchical policy control on the hierarchical data layer based on an approval of a result associated with the local validation testing and the impact analysis process. The method also includes testing the data policy to determine its effectiveness, producing a data sequence diagram, and implementing the data policy that controls the hierarchical data layer comprising an infrastructure provisioning transaction according to a predetermined boundary layer.

### CROSS-REFERENCE TO RELATED APPLICATIONS

This application claims priority benefit from Indian Application No. 202511047973, filed on May 19, 2025 in the India Patent Office, which is hereby incorporated by reference in its entirety.

### FIELD OF THE DISCLOSURE

This technology generally relates to methods and systems for generating a software development framework with at least one hierarchical data policy control on an infrastructure provisioning transaction.

### BACKGROUND INFORMATION

In enterprise operations, the ability to provide a unified management of resources (e.g., computing resources, cloud resources, network resources, etc.) is of paramount importance because it enables enterprises to oversee and manage the security of their operations as conducted globally in a convenient, accessible, and efficient manner. However, since these resources are often disparate resources that are often located in varying locales globally and operated by varying entities, a technique is needed to better manage these resources.

Accordingly, there is a need for techniques that provide a unified management of such resources.

### SUMMARY

The present disclosure, through one or more of its various aspects, embodiments, and/or specific features or sub-components, provides, inter alia, various systems, servers, devices, methods, media, programs, and platforms for generating a software development framework with at least one hierarchical data policy control on an infrastructure provisioning transaction.

According to an aspect of the present disclosure, a method of generating a software development framework with at least one hierarchical data policy control on an infrastructure provisioning transaction may be provided. The method may be implemented by at least one processor. The method may include receiving a data request comprising an infrastructure provisioning transaction request, and developing a data policy correlating to a hierarchical data layer based on the data request. The method may also include performing a local validation testing and performing an impact analysis process of the data policy within a local computing environment. The method may also include generating a software development framework with at least one hierarchical policy control on the hierarchical data layer based on an approval of a result associated with the local validation testing and the impact analysis process. The method may also include testing the data policy against a current data policy via the software development framework to determine an effectiveness of the data policy. The method may also include producing a data sequence diagram for storage in an artifact repository indicating the effectiveness, wherein the data sequence diagram is derived from publishing a testing result. The method may also include implementing the data policy that controls the hierarchical data layer comprising an infrastructure provisioning transaction according to a predetermined boundary layer.

The predetermined boundary layer may include a parent boundary with a parent data node and a child boundary with a child data node. The data policy may include at least one from among an updated data policy and a new data policy.

The performing the local validation testing may include: implementing a policy enforcement engine that performs the local validation testing, determining a validation result that comprises at least one from among a success result and a fail result, and rejecting the data policy upon the determining of the fail result. The performing the local validation testing may also include tagging the data policy with a policy set version upon the determining of the success result, and forwarding the tagged data policy to a downstream application that executes the tagged data policy.

The performing the local validation testing with the implemented policy enforcement engine may include: extracting a context associated with the data request, retrieving a corresponding data policy having a predetermined version from the artifact repository that corresponds to the extracted context, and executing the corresponding data policy on the data request via an open policy agent (OPA) validator application. The performing the local validation testing with the implemented policy enforcement engine may also include framing a data policy evaluation result associated with the corresponding data policy and framing a corresponding validation message, and returning the data policy evaluation result to a caller application.

The developing the data policy may include performing at least one of creating a new data policy and updating the current data policy that results in an updated data policy, and performing a unit test that comprises testing a functional unit of code correlating to the at least one from among the new data policy and the updated data policy. The developing the data policy may also include performing the impact analysis process on a boundary graph, publishing a report on the impact analysis process, and evaluating the unit test and the report.

The developing the data policy may also include determining whether to approve a change in the current data policy with at least one from among the new data policy and the updated data policy. The developing the data policy may also include building the at least one from among the new data policy and the updated data policy via a build application upon the determining to approve the change that results in a built policy, and publishing the built policy with a corresponding policy set version for storage in the artifact repository.

The performing the impact analysis process may include traversing towards a root of a boundary graph, and setting a current data node in the boundary graph as a parent data node. The performing the impact analysis process may also include obtaining association data between the parent data node and a child data node, executing a policy set validation on each of the association data, and generating a data policy evaluation result based on the executing of the policy set validation.

The performing the impact analysis process may further include determining whether the parent data node has a child data node, and performing a loop mechanism that repeats the impact analysis process for the child data node upon the determining that the parent data node has the child data node.

The performing the impact analysis process may further include notifying a user of the data policy evaluation result based on a notification configuration upon the determining that the parent data node does not have the child data node.

According to another embodiment, a computing apparatus for generating a software development framework with at least one hierarchical data policy control on an infrastructure provisioning transaction may be provided. The computing apparatus may include: a processor; a memory; a display; and a communication interface coupled to each of the processor, the memory, and the display.

The processor may be configured to: receive a data request comprising an infrastructure provisioning transaction request, develop a data policy correlating to a hierarchical data layer based on the data request, and perform a local validation testing and performing an impact analysis process of the data policy within a local computing environment. The processor may be further configured to generate a software development framework with at least one hierarchical policy control on the hierarchical data layer based on an approval of a result associated with the local validation testing and the impact analysis process. The processor may be configured to test the data policy against a current data policy via the software development framework to determine an effectiveness of the data policy. The processor may be further configured to produce data sequence diagram for storage in an artifact repository indicating the effectiveness, wherein the data sequence diagram is derived from publishing a testing result. The processor may be configured to implement the data policy that controls the hierarchical data layer comprising an infrastructure provisioning transaction according to a predetermined boundary layer.

The predetermined boundary layer may include a parent boundary with a parent data node and a child boundary with a child data node. The data policy may include at least one from among an updated data policy and a new data policy.

The processor may be further configured to perform the local validation testing by: implementing a policy enforcement engine that performs the local validation testing, determining a validation result that comprises at least one from among a success result and a fail result, and rejecting the data policy upon the determining of the fail result. The processor may be further configured to perform the local validation testing by tagging the data policy with a policy set version upon the determining of the success result, and forwarding the tagged data policy to a downstream application that executes the tagged data policy.

The processor may be further configured to perform the local validation testing with the implemented policy enforcement engine by: extracting a context associated with the data request, retrieving a corresponding data policy having a predetermined version from the artifact repository that corresponds to the extracted context, and executing the corresponding data policy on the data request via an open policy agent (OPA) validator application. The processor may be further configured to framing a data policy evaluation result associated with the corresponding data policy and framing a corresponding validation message, and returning the data policy evaluation result to a caller application.

The processor may be further configured to develop the data policy by: performing at least one of creating a new data policy and updating the current data policy that results in an updated data policy, performing a unit test that comprises testing a functional unit of code correlating to the at least one from among the new data policy and the updated data policy, and performing the impact analysis process on a boundary graph. The processor may be further configured to develop the data policy by: publishing a report on the impact analysis process, evaluating the unit test and the report, and determining whether to approve a change in the current data policy with at least one from among the new data policy and the updated data policy. The processor may be further configured to develop the data policy by building the at least one from among the new data policy and the updated data policy via a build application upon the determining to approve the change that results in a built policy, and publishing the built policy with a corresponding policy set version for storage in the artifact repository.

The processor may be further configured to perform the impact analysis process by: traversing towards a root of a boundary graph, setting a current data node in the boundary graph as a parent data node, and obtaining association data between the parent data node and a child data node. The processor may be further configured to perform the impact analysis process by executing a policy set validation on each of the association data, and generating a data policy evaluation result based on the executing of the policy set validation.

The processor may be further configured to: determine whether the parent data node has a child data node, perform a loop mechanism that repeats the impact analysis process for the child data node upon the determining that the parent data node has the child data node, and notify a user of the data policy evaluation result based on a notification configuration upon the determining that the parent data node does not have the child data node.

According to yet another embodiment, non-transitory computer readable storage medium storing instructions for generating a software development framework with at least one hierarchical data policy control on an infrastructure provisioning transaction may be provided. The non-transitory computer readable storage medium may include executable code which, when executed by a processor, may cause the processor to receive a data request comprising an infrastructure provisioning transaction request, develop a data policy correlating to a hierarchical data layer based on the data request, and perform a local validation testing and performing an impact analysis process of the data policy within a local computing environment. The non-transitory computer readable storage medium may also cause the processor to generate a software development framework with at least one hierarchical policy control on the hierarchical data layer based on an approval of a result associated with the local validation testing and the impact analysis process, and test the data policy against a current data policy via the software development framework to determine an effectiveness of the data policy. The non-transitory computer readable storage medium may also cause the processor to produce a data sequence diagram for storage in an artifact repository indicating the effectiveness, wherein the data sequence diagram is derived from publishing a testing result. The non-transitory computer readable storage medium may also cause the processor to implement the data policy that controls the hierarchical data layer comprising an infrastructure provisioning transaction according to a predetermined boundary layer.

The predetermined boundary layer may include a parent boundary with a parent data node and a child boundary with a child data node. The data policy may include at least one from among an updated data policy and a new data policy.

The non-transitory computer readable storage medium may also cause the processor to perform the local validation testing by: implementing a policy enforcement engine that performs the local validation testing, determining a validation result that comprises at least one from among a success result and a fail result, and rejecting the data policy upon the determining of the fail result. The processor may further perform the local validation testing by tagging the data policy with a policy set version upon the determining of the success result, and forwarding the tagged data policy to a downstream application that executes the tagged data policy.

The non-transitory computer readable storage medium may further cause the processor to perform the local validation testing with the implemented policy enforcement engine by: extracting a context associated with the data request, retrieving a corresponding data policy having a predetermined version from the artifact repository that corresponds to the extracted context, and executing the corresponding data policy on the data request via an open policy agent (OPA) validator application. The processor may be further caused to perform the local validation testing with the implemented policy enforcement engine by framing a data policy evaluation result associated with the corresponding data policy and framing a corresponding validation message, and returning the data policy evaluation result to a caller application.

The non-transitory computer readable storage medium may further cause the processor to develop the data policy by: performing at least one of creating a new data policy and updating the current data policy that results in an updated data policy, performing a unit test that comprises testing a functional unit of code correlating to the at least one from among the new data policy and the updated data policy, and performing the impact analysis process on a boundary graph. The processor may be further caused to develop the data policy by publishing a report on the impact analysis process, evaluating the unit test and the report, and determining whether to approve a change in the current data policy with at least one from among the new data policy and the updated data policy. The processor may be further caused to develop the data policy by building the at least one from among the new data policy and the updated data policy via a build application upon the determining to approve the change that results in a built policy, and publishing the built policy with a corresponding policy set version for storage in the artifact repository.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a software development framework with at least one hierarchical data policy control on an infrastructure provisioning transaction.

FIG. 4 illustrates a flowchart of a process diagram for generating a software development framework with at least one hierarchical data policy control on an infrastructure provisioning transaction according to an embodiment.

FIG. 5 illustrates an example overview framework of the generating a software development framework with at least one hierarchical data policy control on an infrastructure provisioning transaction according to an embodiment.

FIG. 6 illustrates an example of request processing according to an embodiment.

FIG. 7 illustrates an example of data policy enforcement according to an embodiment.

FIG. 8 illustrates an example of data policy authoring according to an embodiment.

FIG. 9 illustrates an example of a data policy set impact analysis process according to an embodiment.

FIG. 10 illustrates an example component diagram of a data policy software development life cycle in conjunction with trust services according to an embodiment.

FIG. 11 illustrates an example boundary diagram depicting hierarchical boundaries and data policy set according to an embodiment.

### DETAILED DESCRIPTION

In enterprise operations, the ability to provide a unified management of resources (e.g., computing resources, cloud resources, network resources, etc.) is of paramount importance because it enables enterprises to oversee and manage the security of their operations as conducted globally in a convenient, accessible, and efficient manner. However, since these resources are often disparate resources that are often located in varying locales globally and operated by varying entities, a technique is needed to better manage these resources.

The present application improves on the status quo and provides a technological improvement by disclosing techniques and processes related to a unified control plane for managing of resources. The resources can be computing resources, infrastructure resources, network resources, cloud resources, etc. For effective risk and control management, a software development framework that enable boundary construction may generated and implemented. A boundary may denote a logical grouping of resources that have compatible control requirements in terms of data, computing operations, and networking operations. These boundaries can form a nested hierarchical tree of nodes such as a parent/root boundary, sub-root boundary, and a child boundary. Every node can be necessitated to comply to controls enforced by its parent/root node. The terms node and boundary may be used interchangeably to denote the same concept.

Additionally, for an infrastructure provisioning transaction request associated with a node (i.e., resource and the infrastructure that such resource entails), this request should be validated prior to being processed for implementation to ensure that the infrastructure provisioning transaction detailed within the request meets the control requirements of a parent node (if any), as well as the control requirements of that node itself. The validation may involve a validation framework, as part of the software development framework, that utilizes a data policy model that is agnostic of the environment and control policies to facilitate adaptive dynamic validations. The software development framework may be data driven or configuration driven when control policies are externalized.

That is, every infrastructure provisioning transaction request would need to be validated against a collection of enterprise control policies. The validation principles in these control policies may hierarchical, whereas regular policies are binary in nature. These policy data sets may be made available to validation framework that validate the infrastructure provisioning transaction request. These policy data sets may be made available as versioned data bundles as part of a governed data policy development lifecycle process. Additionally. provisioned infrastructure may be annotated with respective policy bundle version, which can help with facilitating audits and reconcile operational aspects related to when a new policy set is going to be applied.

Indeed, the software development framework may enable a strategic control plane for managing an enterprise's resources, such as the multi-clouds for workload deployments grouped that may be grouped into logical compute and network boundaries.

A technological advantage of the software development framework may be in providing a software mechanism to apply multiple policy bundles on infrastructure provisioning transactions and annotation of these transactions with which version of policy bundles may be validated. This enables seamless electronic audit of validation policies within an enterprise. Another technological advantage of the software development framework may be in decoupling data policy bundles and validation service to enable externalization and dynamic adoption of data policies by validation services.

Another technological advantage of the software development framework may be in externalization of data policies by facilitating a collaborative software framework between control administrators and validation service engineers. Another technological advantage may be annotation of a provisioned infrastructure with applied data policy bundle version that facilitates the ability to analyze the impacts of new/to-be published data policy bundles and thereby, deducing remediate/reconcile steps for existing infrastructure. Another technological advantage may be analysis and reconciliation of data policy conflicts across the hierarchy, as well as recommendations for controls posture improvement.

Thus, the generation of the software development framework that enable boundary construction in the particular manner as described in the present application provides a technological improvement through its operations in providing a unified management of resources as described in the present application.

For these various reasons, the present application provides a technological improvement of the status quo. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

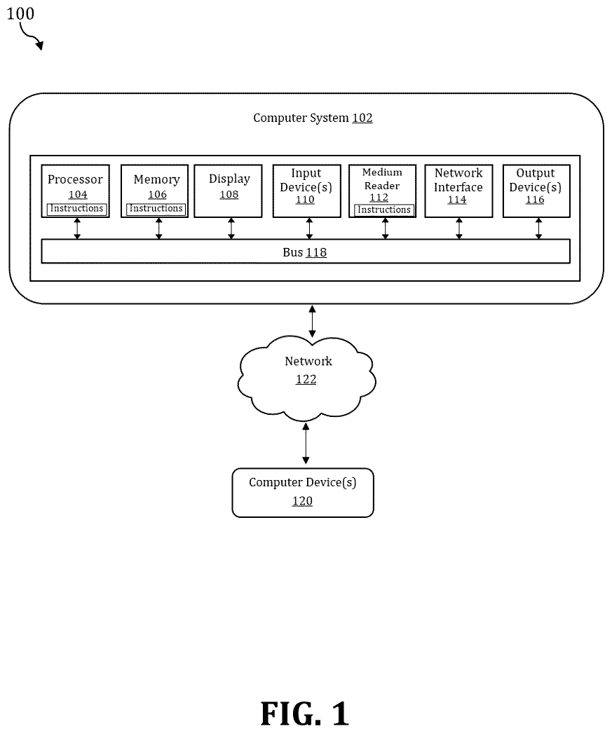

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating a software development framework with at least one hierarchical data policy control on an infrastructure provisioning transaction.

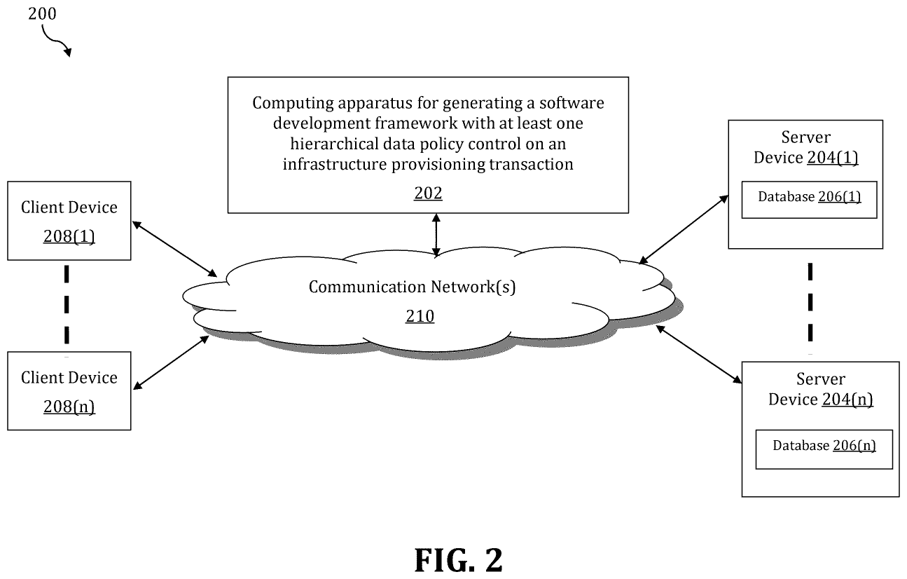

Referring to FIG. 2, a network diagram of a network environment 200 for generating a software development framework with at least one hierarchical data policy control on an infrastructure provisioning transaction may be illustrated. In an embodiment, the method may be executable on any networked computer platform, such as, for example, a personal computer (PC).

The methods for generating a software development framework with at least one hierarchical data policy control on an infrastructure provisioning transaction may be implemented by a computing apparatus 202 that implements generating a software development framework with at least one hierarchical data policy control on an infrastructure provisioning transaction. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a software development framework with at least one hierarchical data policy control on an infrastructure provisioning transaction.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

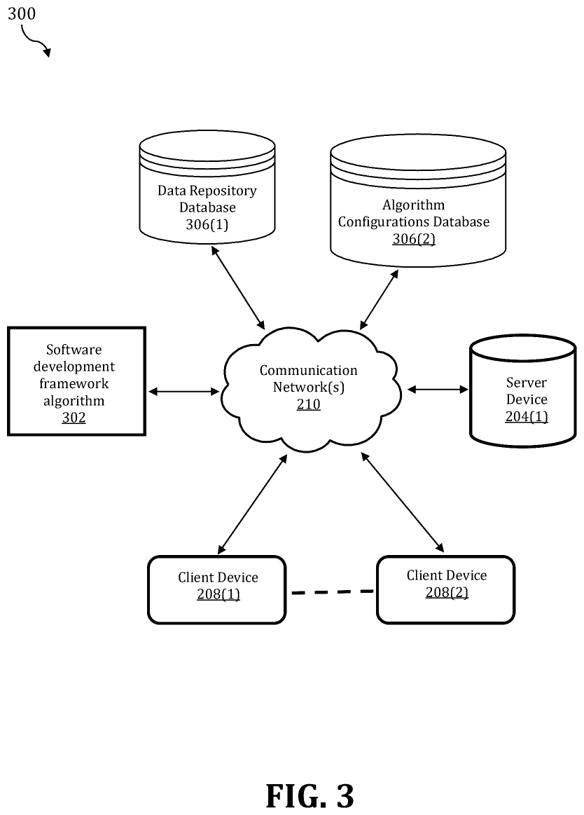

The computing apparatus 202 may be described and illustrated in FIG. 3 as may include a software development framework algorithm 302, although it may include other rules, algorithms, policies, modules, databases, or applications, for example. As will be described below, the software development framework algorithm 302 may be configured to implement method of generating a software development framework with at least one hierarchical data policy control on an infrastructure provisioning transaction.

FIG. 3 illustrates a diagram of a system environment 300 for implementing method of generating a software development framework with at least one hierarchical data policy control on an infrastructure provisioning transaction by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The software development framework algorithm 302 may be configured to access these databases for implementing the method of generating a software development framework with at least one hierarchical data policy control on an infrastructure provisioning transaction.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

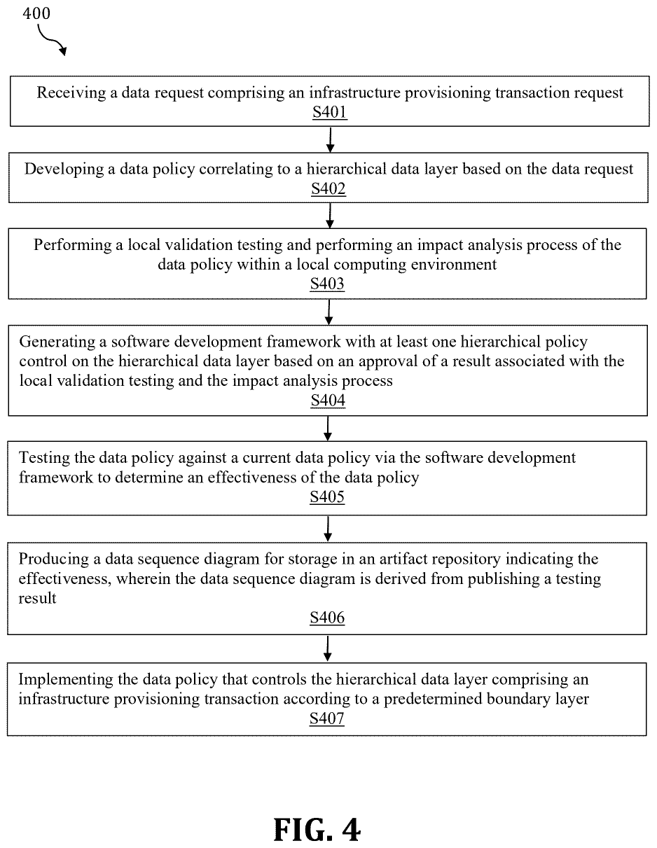

The software development framework algorithm 302 may execute a process implementing method of generating a software development framework with at least one hierarchical data policy control on an infrastructure provisioning transaction. The process for generating a software development framework with at least one hierarchical data policy control on an infrastructure provisioning transaction may be generally indicated at flowchart 400 in FIG. 4.

FIG. 4 illustrates a flowchart of a process diagram 400 of a process for generating a software development framework with at least one hierarchical data policy control on an infrastructure provisioning transaction according to an embodiment. The process diagram 400 may be implemented by the system environment 300 of FIG. 3, a network environment 200 of FIG. 2, and the system 100 of FIG. 1.

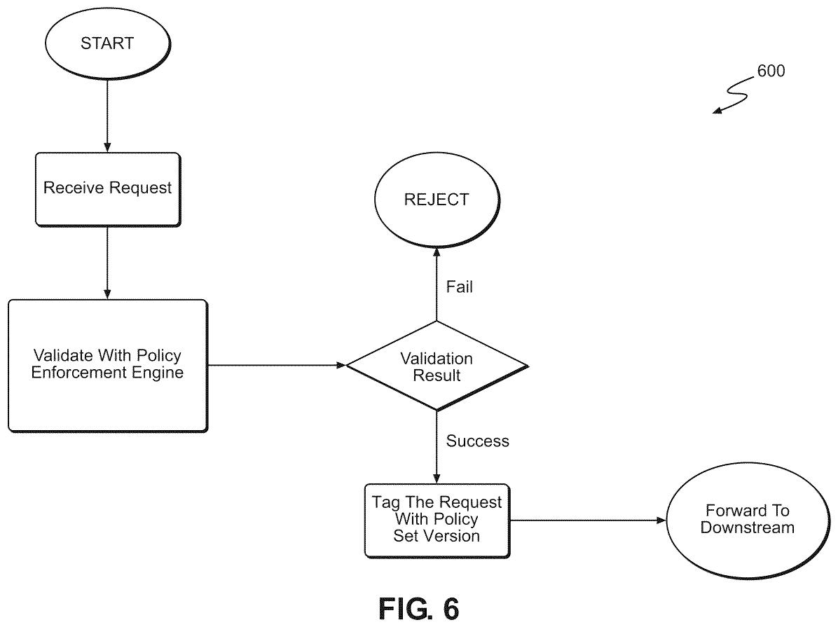

At step S401 of the flowchart process 400, the computing apparatus 202 may receive a data request comprising an infrastructure provisioning transaction request. Further details are described in FIG. 6.

At step S402 of the flowchart process 400, the computing apparatus 202 may develop a data policy correlating to a hierarchical data layer based on the data request. The data policy may include at least one from among an updated data policy and a new data policy.

At step S403 of the flowchart process 400, the computing apparatus 202 may perform a local validation testing and performing an impact analysis process of the data policy within a local computing environment.

Continuing with step S404 of the flowchart process 400, the computing apparatus 202 may generate a software development framework with at least one hierarchical policy control on the hierarchical data layer based on an approval of a result associated with the local validation testing and the impact analysis process.

Continuing with step S405 of the flowchart process 400, the computing apparatus 202 may testing the data policy against a current data policy via the software development framework to determine an effectiveness of the data policy

At step S406 of the flowchart process 400, the computing apparatus 202 may produce a data sequence diagram for storage in an artifact repository indicating the effectiveness, wherein the data sequence diagram is derived from publishing a testing result.

At step S407 of the flowchart process 400, the computing apparatus 202 may implement the data policy that controls the hierarchical data layer comprising an infrastructure provisioning transaction according to a predetermined boundary layer. The predetermined boundary layer may include a parent boundary with a parent data node and a child boundary with a child data node.

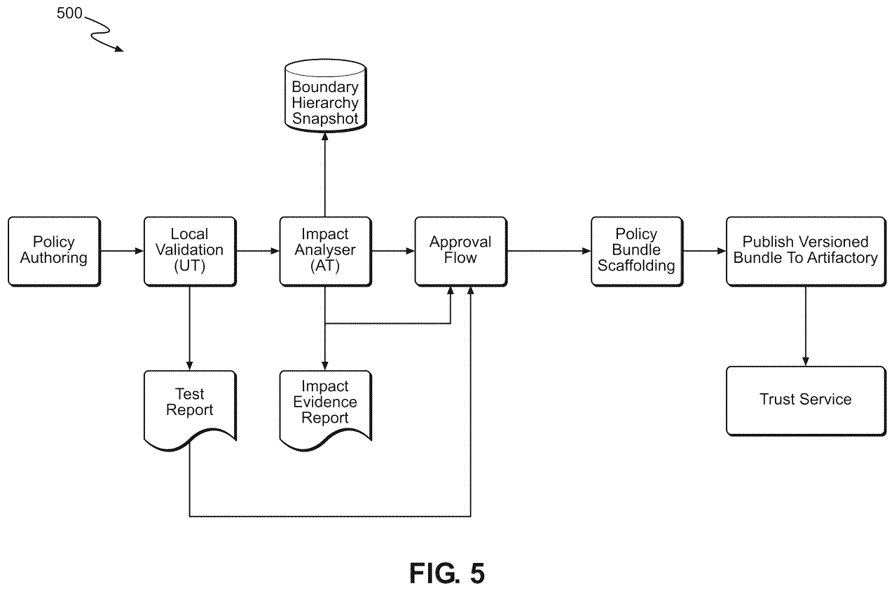

FIG. 5 illustrates an example overview process 500 for generating a software development framework with at least one hierarchical data policy control on an infrastructure provisioning transaction according to an embodiment as described in FIG. 4 at steps S401-S407. The example overview process 500 may begin with a policy authoring (i.e., developing a data policy), followed by performing a local validation testing (via unit testing) and generating a unit test report. The example overview process 500 may also include an impact analyzer for performing an impact analysis process, followed by generating an impact evidence report and a snapshot of a boundary hierarchy. Regarding the impact analyzer, a new data policy or modification to an existing data policy can be tested via the impact analyzer process to analyze its effects on existing infrastructure node graph. This assists in determining whether the approve a change in favor of the new data policy or not.

The example overview process 500 may also include an approval flow which may be based on evaluating the test report and the impact evidence report. The example overview process 500 may also include a scaffolding of a policy bundle and publishing the versioned bundle to an artifact repository, i.e. artifactory. The artifactory can be a central registry. Scaffolding can denote a build phase for building a policy set using build applications. Regarding the publishing of the versioned bundle to the artifact repository, provision infrastructure resources may be annotated with a version of a policy set that they are validated with, which helps in a policy audit.

Continuing with FIG. 5, since data policies may be externalized, the example overview process 500 may show an overview process that enables a data policy to undergo a governed development life cycle before being applied to live software computing environment where there are active infrastructure provisioning requests.

The example overview process 500 may also include a trust service. The trust service may support more than one data policy bundle validation. For instance, one version bundle may be in an enforcement mode, while another bundle may be in a testing mode or a warning mode. The trust service may be configured to a specific data shard.

Thus, example overview process 500 describes the generating a software development framework wherein data policies may go through a development life cycle process which comprises of testing and impact analysis phases. Evidence reports of these testing and impact analysis phases may be taken as inputs for approving the newly added updated data policy (i.e., modification of existing data policies). Approval may then result in scaffolding of a new versioned data policy bundle and published to a central artifactory, which can then be consumed by a validation process that can be implemented via a validation framework. The validation framework being part of the software development framework. The validation framework can execute the approved data policy set in a test mode along with current existing version of policy set. The validated data policy sets may be annotated with enforced and tested versions of the data policy sets. These annotations can help with deducing the impacts on existing infrastructure when a new control is added or existing control is modified.

FIG. 6 illustrates an example of request processing 600 according to an embodiment as described in steps S401 and S403 of FIG. 4. The request processing 600 may begin upon receiving a data request, the data request may relate to an infrastructure provisioning transaction request. Upon developing a data policy correlating to a hierarchical data layer based on the data request, a local validation testing may be performed. The performing the local validation testing may include implementing a policy enforcement engine that performs the local validation testing, and determining a validation result that involves either a success result or a fail result. Upon determining the validation result is fail, then rejecting the data policy. If the validation result is determined to be successful, then tagging the data policy with a policy set version upon the determining of the success result, and forwarding the tagged data policy to a downstream application that executes the tagged data policy.

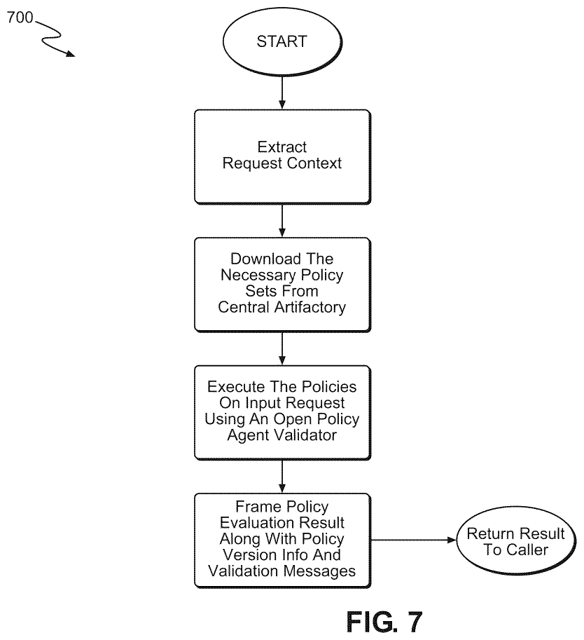

FIG. 7 illustrates an example of data policy enforcement 700 according to an embodiment as described in steps S401 and S403 of FIG. 4 and as related to the example request processing 600 of FIG. 6. The example policy enforcement 700 may relate to the performing the local validation testing with the implemented policy enforcement engine. The example policy enforcement 700 may begin with extracting a context associated with the data request, and retrieving (e.g., downloading) a corresponding data policy having a predetermined version from the artifact repository that corresponds to the extracted context. The decision to download a specific policy set is dependent on the request context details. Some examples of the request context details can include, but are not limited to: regional information, organizational information, and type of request. Multiple policy sets can be executed with e.g., a maximum of one version in an enforcement mode and another version remain in a warning mode.

The data policy enforcement 700 may continue with executing the corresponding data policy on the data request via an open policy agent (OPA) validator application, framing a data policy evaluation result associated with the corresponding data policy and framing a corresponding validation message, and returning the data policy evaluation result to a caller application.

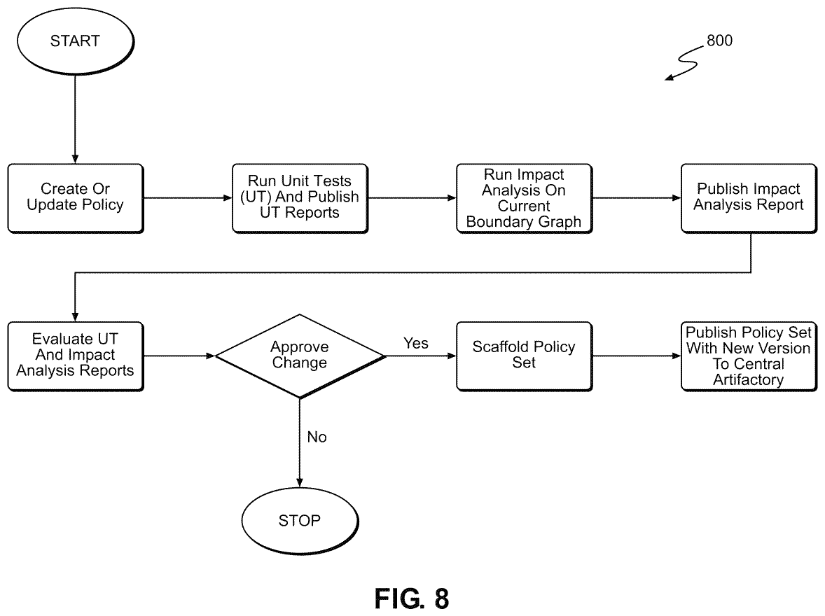

FIG. 8 illustrates an example of data policy authoring 800, i.e., developing a data policy, according to an embodiment as described in step S402 of FIG. 4. The example of the data policy authoring 800, i.e., the developing the data policy, may begin with an initial step of performing either a creation of a new data policy or updating the current data policy that results in an updated data policy, and performing a unit test that comprises testing a functional unit of code correlating to either the new data policy or the updated data policy. A unit test is a process that in software program development wherein the smallest functional unit of code is tested. Such testing helps to ensure code quality and that it operates as desired. In the present case, this smallest functional unit of code relates to either the new data policy or the updated data policy, depending on whether the initial step in the example of the data policy authoring 800 is creation of a new data policy or updating the current data policy. Upon the completion of the unit testing, a unit testing report may be published.

The example of the data policy authoring 800 may also include performing the impact analysis process on a boundary graph, and upon its completion, publishing a report on the impact analysis process. The example of the data policy authoring 800 may also include evaluating the unit test and the report on the impact analysis process. That is, the reports regarding the unit testing and the impact analysis process are evaluated.

The example of the data policy authoring 800 may also include determining whether to approve a change in the current data policy with either the new data policy or the updated data policy. If the change is approved, then performing a scaffold policy set. That is, building either the new data policy or the updated data policy via a build application based on the determining to approve the change, which results in a built policy. The example of policy authoring 800 may also include publishing the built policy with a corresponding policy set version for storage in the artifact repository. If the change is not approved, then stopping the policy authoring process. That is, stopping the developing of the data policy process and remaining with the current data policy (if the initial step was updating the current data policy) or remaining with a previous data policy (if the initial step was creating a new data policy)

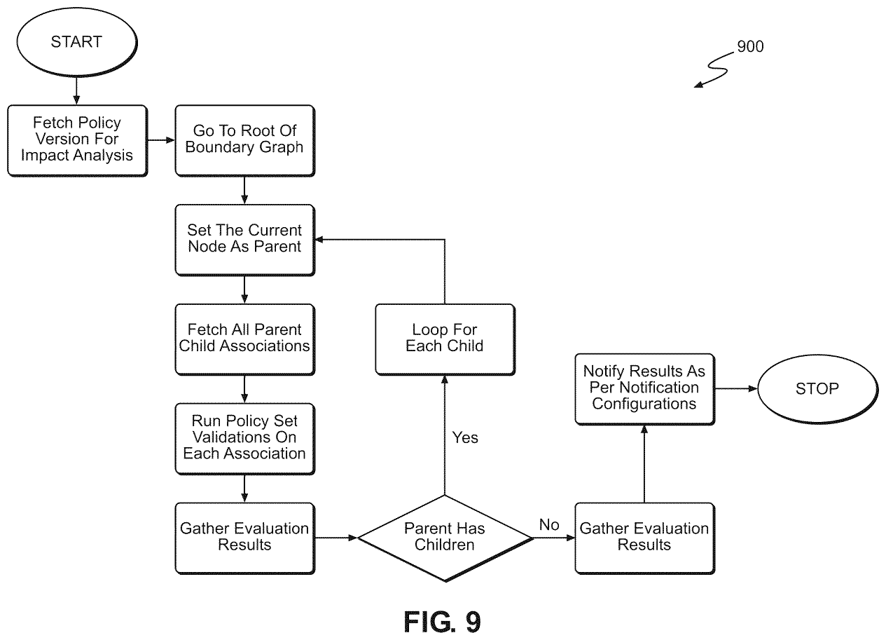

FIG. 9 illustrates an example of data policy set impact analysis process 900 according to an embodiment as described in step S403 of FIG. 4. The example of the data policy set impact analysis process 900 may begin with traversing towards a root of a boundary graph, setting a current data node in the boundary graph as a parent data node, and obtaining association data between the parent data node and a child data node. The example of the data policy set impact analysis process 900 may also include executing a data policy set validation on each of the association data, and generating a data policy evaluation result based on the executing of the policy set validation.

The example of the data policy set impact analysis process 900 may also include determining whether the parent data node has a child data node, and performing a loop mechanism that repeats the impact analysis process for the child data node upon the determining that the parent data node has the child data node. That is, if there is a child node, then the impact analysis process steps of: setting a current data node in the boundary graph as a parent data node, obtaining association data between the parent data node and a child data node, executing a policy set validation on each of the association data, and generating a data policy evaluation result based on the executing of the policy set validation are repeated until a terminal condition is reached. The terminal condition can be when it is determined that the parent node has no child node. Then, the loop mechanism is no longer performed because a repetition is no longer needed.

Continuing with the example of policy set impact analysis process 900, if it has been determined that the parent node has no child node, then the process proceeds to notifying a user of the data policy evaluation result based on a notification configuration and the example of policy set impact analysis process 900 can stopped because it has been completed.

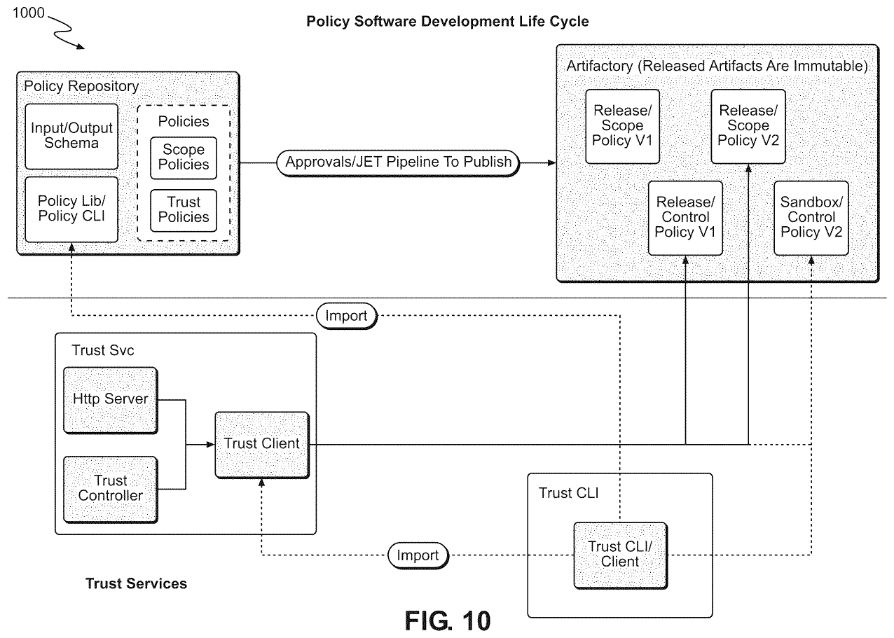

FIG. 10 illustrates an example component diagram 1000 of a data policy software development life cycle in conjunction with trust services according to an embodiment as described in steps S402-S407 of FIG. 4. The example component diagram 1000 may show an externalization of policies and control configurations from a validation engine that involves a policy software development life cycle in conjunction with trust services.

The example component diagram 1000 may show, as part of the data policy software development life cycle, a data policy repository with input/output schema, data policy library/policy command line interface (CLI), and the various data policies (e.g. scope policies, trust policies, etc.). The data policy CLI may enable an interface for testing data policies, and the data policy CLI may denote a software tool/application that can be executed from an interface command line. Additionally, the data policy library and data policy CLI may be further developed as a data policy forum for the input/output schema. Regarding the various data policies, changes in data policies may require proper approval and data policies will be versioned along with corresponding input/output schema. Scope policies may denote a collection of key-value pairs (e.g., scoping attributes) related to the data policy.

Continuing with the data policy software development life cycle of the example component diagram 1000, once the data policies are approved, they may be published via a software build pipeline such as a JET pipeline. The data policies may include release/scope policy versions and may be published to an artifactory.

Moving on to the trust services of the example component diagram 1000, the trust services can include a trust service and a trust service CLI/client. The trust service can include a hypertext transfer protocol (HTTP) server, a trust controller, and a trust client. The HTTP server can incorporate existing functionality of webhooks and pre-validation endpoints of external systems for data policies. Webhooks may denote software applications that enable real-time communications between various applications wherein one application can notify another application when a particular event has occurred. For example, a real-time notification between applications when a validation or pre-validation of a data policy has occurred.

Continuing with the trust services of the example component diagram 1000, the trust controller can run reconciliation of a new version of the data policy and build notifications or metrics on existing resources for any incompatibility. The trust client can provide information to the artifactory regarding the data policies release/scope policy versions. Reconciliation process may include notifications and approvals followed by reconciliation.

Approvals may include a collection of control identifiers for making authorization decisions regarding resources that can be provisioned based on a deployment scope. A deployment scope may describe specifications that include, but are not limited to: deployment intent, required functions, scope (e.g., attribute information), environment, and approved controls.

Continuing with the trust services of the example component diagram 1000, the trust service CLI/client can convert resource schema, and can be used to help perform impact analysis process for a new data policy version. The information from the trust service CLI/client can be sent to the data policy library/policy CLI, the artifactory regarding the data policies release/scope policy versions, and the trust client. These components can import the information from the trust service CLI/client for their operations.

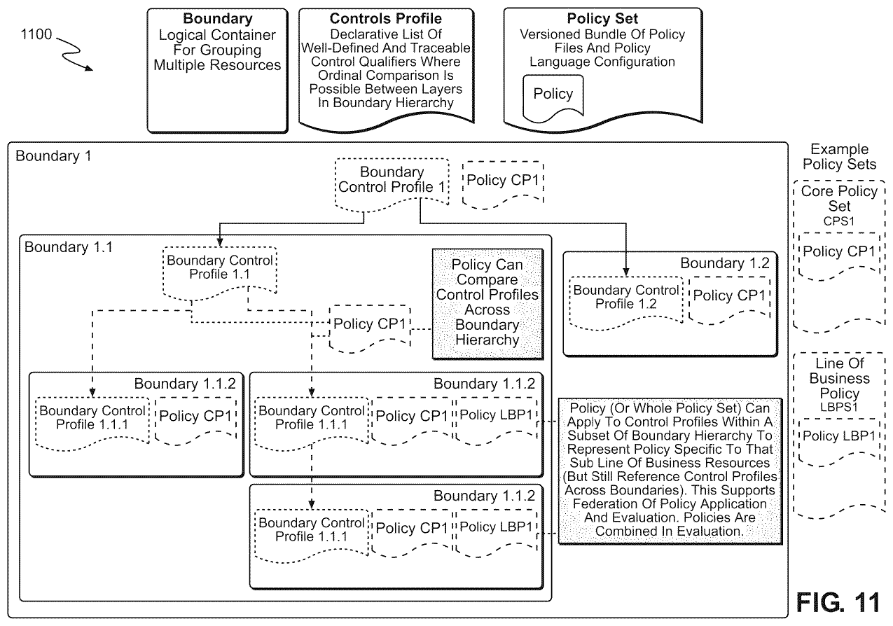

FIG. 11 illustrates an example boundary diagram 1100 depicting hierarchical boundaries and data policy set according to an embodiment. The example boundary diagram 1100 shows boundaries, control profiles (CP), and data policy sets.

The data policy set may be a combination of different data policies (e.g., rules and control profiles). The data policy sets may need a contribution model because control specifications can come from multiple different teams of an enterprise. Thus, a contribution model would enable all the different control specifications to be implemented.

A data policy set may be a bundled collection of data policy files and requisite data configurations. The data policy files may be written by a data policy programming language such as, but not limited to, REGO. REGO is a programming language used for implementing policies and can be implemented by general-purpose policy engine such as that operated by Open Policy Agent (OPA). While REGO and OPA are described, these are examples, and any other applicable programming language and general-purpose policy engine can be utilized.

A data policy may take a request input and data configurations as parameters to perform specific validations (e.g., control compatibility, environment specific conditional checks, etc.). Data configurations may include files that comprise of data policies need for validations. It may be noted that a published data policy set can be a versioned artifact that can be referenced from a central repository (e.g., an artifactory). Some examples of data policy validation can include A/B testing, audit tagging, etc. Data policy validation can be performed via data policy enforcement 700 as described in FIG. 7.

A boundary as part of a boundary concept can be a logical container for grouping multiple resources. That is, the boundary concept can be a hierarchical framework designed to manage and secure cloud environments through distinct levels of control and organization. The specification of a boundary can encapsulate attributes/characteristics that act as constraints to place/associate a resource to respective boundary. These characteristics can be control or computer or network related. Resources can be e.g., computing resources, infrastructure resources, network resources, cloud resources, etc. Additionally, a boundary can also have child boundaries (e.g., nested boundaries). Constraints set at an outer boundary should be met by an inner boundary. An inner boundary can be set with further tightening constraints). For example, a parent node can have a child node, wherein each node has their respective boundaries and are constrained within those boundaries. The child node having a tighter constraint than a parent node if a child node is contained as a subset within the parent node.

The hierarchical framework of the boundary concept may include a deployment scope, a portfolio boundary, a network boundary, and a workload boundary. A deployment scope may define ownership associated with the different boundaries and layers, and may be used in establishing trust between different layers of the boundary hierarchy from Organizational Unit to actual deployment of a workload. Each deployment scope may drive the creation of the corresponding boundary or workload via scoped roles. The deployment scope may be specific to a control environment (e.g. a software developing computing environment, a software test computing environment, a software production computing environment, etc.).

A portfolio boundary may serve as a logical container to group accounts, shared virtual private clouds. The portfolio boundary may also apply policies, enabling consistent control across similar applications and facilitating intra-application communication within the same portfolio boundary. The portfolio boundary can apply top-level controls via native cloud provider mechanisms and contains network boundaries, workload boundaries, and workloads.

A network boundary can be composed of one or more virtual networks (e.g., virtual private clouds). Network boundaries can provide isolated networking capabilities, defining reachability and connectivity for workloads. Network boundaries can be expressed through cloud-native constructs, whereby a single portfolio boundary can contain multiple network boundaries based on workload requirements.

A workload boundary may refine workload placement within a portfolio boundary or a network boundary by isolating related workloads, and offering administrative capabilities like access and billing. Workload boundaries can facilitate small account design for lifecycle management and can host multiple workloads, but may be associated with just one network boundary.

A trust service may be implemented to act as a security enforcement point, ensuring that only compatible boundaries with appropriate scope and control profiles may be nested within higher logical boundaries. The trust service enforces rules related to boundary validation, parent-child boundary association, and control alignment.

A boundary validation can ensure that every satisfied control within a boundary does not exceed the approved controls of its deployment scope. The boundary validation may include logical resource boundaries, which can enable an arrangement based on a logical resource as arranged via a hierarchy ranging from portfolio boundary to network boundary, and finally to workload boundary.

A parent-child boundary association may validate that at least one trusted scope in the parent's collection is a subset of the child's deployment scope attributes. Trusted scope controls for a boundary may be constraints on which deployment scopes are trusted to deploy into a boundary using a collection of environment-agnostic key-value pairs that may be a part of a boundary specification. The trusted scope controls may be defined as:

```
“trustedScopes” : [ {
  “attribute1” : “value1”,
  “attribute2” : “value2”
} ]
```

Continuing with the parent-child boundary association, key-value pairs should be environment agnostic to enable their operation across different computing/operational environments. These key-value pairs can be used to deduce whether a child boundary can be added to a parent boundary based on an approved deployment scope (DS). Examples of such validation may be shown in Table 1. The checks in Table 1 need to be passed for a child boundary to be added to a parent boundary.

TABLE 1
Validation checks for determining whether a child
boundary can be added to a parent boundary.

| Child boundary | Validation | Parent boundary |
|---|---|---|
| DS approved controls | should be same or | parent resource spec |
| | stronger than | satisfied controls |
| DS approved controls | should match to | trusted scope data set |
| and scoping attributes | at least one of | collection of boundary |
| | | resource specifications |
| DS environment | should be the same as | DS environment |

The control alignment may confirm that each control in the child boundary's satisfied controls either matches or is lower than the parent boundary's satisfied controls. This control alignment framework ensures a secure and compliant deployment within the logical boundaries. The control alignment has several types of control types and hierarchy including approved controls and satisfied controls.

The approved controls may be defined at the deployment scope level, these controls may represent the highest permissible parameters, including payment card information (PCI), data classification, service organization controls (SOCs), health information trust alliance (HITRUST), connectivity, jurisdiction, and Sarbanes-Oxley (SOX) Act controls. The satisfied controls may include specific controls enforced by a boundary, which must align with or be lower than the approved controls of the deployment scope of a particular owner/organization.

A satisfied control for a boundary may be a collection of control identifiers that can be a part of a boundary specification. A satisfied control should be specified in such a way that overall control cannot be escalated beyond a deployment scope control. Validation of a boundary's satisfied control can be performed at multiple instances such as via resource provisioning interface, a respective boundary factory, etc.

A summary of satisfied control, as well as approved control and control bounds for a boundary may be shown in Table 2. These constructs provide a mechanism for the control validation logic.

TABLE 2
Constructs for control validation logic.

| | |
|---|---|
| Approved controls | Defined at deployment scope level. In |
| | general, this may be set to the highest |
| | possible control parameters that the |
| | respective deployment scope can be |
| | authorized to implement. |
| | This attribute is defined at a deployment |
| | scope level because there could be more than |
| | one resource (e.g., boundary or native |
| | resource) that is being operated by a specific |
| | deployment scope. |
| Satisfied controls | May be defined at resource boundary level. |
| | In general, this may be set to lower level |
| | control parameters that a respective boundary |
| | can enforce. |
| Control bounds | Authorizes the deployment of resources |
| | whose risk characteristics (e.g., required |
| | controls) fall within the bounds of what a |
| | boundary trusts (e.g., trusted |
| | scope controls) and what the boundary can |
| | enforce (e.g., satisfied controls). |

A resource can depicted as being located within the boundary of the inner boundary, whereby enforcement of constraints in placing a resource into a boundary can be realized by executing configurable policy sets with a foundational service such as a trust service.

Required control may be controls on individual or native resources that may have tagged values applied to them. Required controls may perform checks on boundaries by validating that the child trusted scope control attributes and any satisfied controls all lie within the bounds of the parent boundary's trusted scope and the parent boundary's satisfied control. This validation can be done by the trust service as invoked by the factories. That is, multiple checks may be performed as applicable.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of generating a software development framework with at least one hierarchical data policy control on an infrastructure provisioning transaction, the method being implemented by at least one processor, the method comprising:
receiving a data request comprising an infrastructure provisioning transaction request;
developing a data policy correlating to a hierarchical data layer based on the data request;
performing a local validation testing and performing an impact analysis process of the data policy within a local computing environment;
generating a software development framework with at least one hierarchical policy control on the hierarchical data layer based on an approval of a result associated with the local validation testing and the impact analysis process;
testing the data policy against a current data policy via the software development framework to determine an effectiveness of the data policy;
producing a data sequence diagram for storage in an artifact repository indicating the effectiveness, wherein the data sequence diagram is derived from publishing a testing result; and
implementing the data policy that controls the hierarchical data layer comprising an infrastructure provisioning transaction according to a predetermined boundary layer.

2. The method of claim 1, wherein the predetermined boundary layer comprises a parent boundary with a parent data node and a child boundary with a child data node; and
wherein the data policy comprises at least one from among an updated data policy and a new data policy.

3. The method of claim 1, wherein the performing the local validation testing comprises:
implementing a policy enforcement engine that performs the local validation testing;
determining a validation result that comprises at least one from among a success result and a fail result;
rejecting the data policy upon the determining of the fail result;
tagging the data policy with a policy set version upon the determining of the success result; and
forwarding the tagged data policy to a downstream application that executes the tagged data policy.

4. The method of claim 3, wherein the performing the local validation testing with the implemented policy enforcement engine comprises:
extracting a context associated with the data request;
retrieving a corresponding data policy having a predetermined version from the artifact repository that corresponds to the extracted context;
executing the corresponding data policy on the data request via an open policy agent (OPA) validator application;
framing a data policy evaluation result associated with the corresponding data policy and framing a corresponding validation message; and
returning the data policy evaluation result to a caller application.

5. The method of claim 1, wherein the developing the data policy comprises:
performing at least one of creating a new data policy and updating the current data policy that results in an updated data policy;
performing a unit test that comprises testing a functional unit of code correlating to the at least one from among the new data policy and the updated data policy;
performing the impact analysis process on a boundary graph;
publishing a report on the impact analysis process;
evaluating the unit test and the report;
determining whether to approve a change in the current data policy with at least one from among the new data policy and the updated data policy;
building the at least one from among the new data policy and the updated data policy via a build application upon the determining to approve the change that results in a built policy; and
publishing the built policy with a corresponding policy set version for storage in the artifact repository.

6. The method of claim 1, wherein the performing the impact analysis process comprises:
traversing towards a root of a boundary graph;
setting a current data node in the boundary graph as a parent data node;
obtaining association data between the parent data node and a child data node;
executing a policy set validation on each of the association data; and
generating a data policy evaluation result based on the executing of the policy set validation.

7. The method of further claim 6, further comprising:
determining whether the parent data node has a child data node; and
performing a loop mechanism that repeats the impact analysis process for the child data node upon the determining that the parent data node has the child data node.

8. The method of further claim 7, further comprising:
notifying a user of the data policy evaluation result based on a notification configuration upon the determining that the parent data node does not have the child data node.

9. A computing apparatus for generating a software development framework with at least one hierarchical data policy control on an infrastructure provisioning transaction, comprising:
a processor;
a memory;
a display; and
a communication interface coupled to each of the processor, the memory, and the display, wherein the processor is configured to:
receive a data request comprising an infrastructure provisioning transaction request;
develop a data policy correlating to a hierarchical data layer based on the data request;
perform a local validation testing and performing an impact analysis process of the data policy within a local computing environment;
generate a software development framework with at least one hierarchical policy control on the hierarchical data layer based on an approval of a result associated with the local validation testing and the impact analysis process;
test the data policy against a current data policy via the software development framework to determine an effectiveness of the data policy;
produce data sequence diagram for storage in an artifact repository indicating the effectiveness, wherein the data sequence diagram is derived from publishing a testing result; and
implement the data policy that controls the hierarchical data layer comprising an infrastructure provisioning transaction according to a predetermined boundary layer.

10. The computing apparatus of claim 9, wherein the predetermined boundary layer comprises a parent boundary with a parent data node and a child boundary with a child data node; and
wherein the data policy comprises at least one from among an updated data policy and a new data policy.

11. The computing apparatus of claim 9, wherein the processor is further configured to perform the local validation testing by:
implementing a policy enforcement engine that performs the local validation testing;
determining a validation result that comprises at least one from among a success result and a fail result;
rejecting the data policy upon the determining of the fail result;
tagging the data policy with a policy set version upon the determining of the success result; and
forwarding the tagged data policy to a downstream application that executes the tagged data policy.

12. The computing apparatus of claim 11, wherein the processor is further configured to perform the local validation testing with the implemented policy enforcement engine by:
extracting a context associated with the data request;
retrieving a corresponding data policy having a predetermined version from the artifact repository that corresponds to the extracted context;
executing the corresponding data policy on the data request via an open policy agent (OPA) validator application;
framing a data policy evaluation result associated with the corresponding data policy and framing a corresponding validation message; and
returning the data policy evaluation result to a caller application.

13. The computing apparatus of claim 9, wherein the processor is further configured to develop the data policy by:
performing at least one of creating a new data policy and updating the current data policy that results in an updated data policy;
performing a unit test that comprises testing a functional unit of code correlating to the at least one from among the new data policy and the updated data policy;
performing the impact analysis process on a boundary graph;
publishing a report on the impact analysis process;
evaluating the unit test and the report;
determining whether to approve a change in the current data policy with at least one from among the new data policy and the updated data policy;
building the at least one from among the new data policy and the updated data policy via a build application upon the determining to approve the change that results in a built policy; and
publishing the built policy with a corresponding policy set version for storage in the artifact repository.

14. The computing apparatus of claim 9, wherein the processor is further configured to perform the impact analysis process by:
traversing towards a root of a boundary graph;
setting a current data node in the boundary graph as a parent data node;
obtaining association data between the parent data node and a child data node;
executing a policy set validation on each of the association data; and
generating a data policy evaluation result based on the executing of the policy set validation.

15. The computing apparatus of claim 14, wherein the processor is further configured to:
determine whether the parent data node has a child data node;
perform a loop mechanism that repeats the impact analysis process for the child data node upon the determining that the parent data node has the child data node; and
notify a user of the data policy evaluation result based on a notification configuration upon the determining that the parent data node does not have the child data node.

16. A non-transitory computer readable storage medium storing instructions for generating a software development framework with at least one hierarchical data policy control on an infrastructure provisioning transaction, the non-transitory computer readable storage medium comprising executable code which, when executed by a processor, causes the processor to:
receive a data request comprising an infrastructure provisioning transaction request;
develop a data policy correlating to a hierarchical data layer based on the data request;
perform a local validation testing and performing an impact analysis process of the data policy within a local computing environment;
generate a software development framework with at least one hierarchical policy control on the hierarchical data layer based on an approval of a result associated with the local validation testing and the impact analysis process;
test the data policy against a current data policy via the software development framework to determine an effectiveness of the data policy;
produce a data sequence diagram for storage in an artifact repository indicating the effectiveness, wherein the data sequence diagram is derived from publishing a testing result; and
implement the data policy that controls the hierarchical data layer comprising an infrastructure provisioning transaction according to a predetermined boundary layer.

17. The non-transitory computer readable storage medium of claim 16, wherein the predetermined boundary layer comprises a parent boundary with a parent data node and a child boundary with a child data node; and
wherein the data policy comprises at least one from among an updated data policy and a new data policy.

18. The non-transitory computer readable storage medium of claim 16, wherein the executable code causes the processor to perform the local validation testing by:
implementing a policy enforcement engine that performs the local validation testing;
determining a validation result that comprises at least one from among a success result and a fail result;
rejecting the data policy upon the determining of the fail result;
tagging the data policy with a policy set version upon the determining of the success result; and
forwarding the tagged data policy to a downstream application that executes the tagged data policy.

19. The non-transitory computer readable storage medium of claim 18, wherein the executable code further causes the processor to perform the local validation testing with the implemented policy enforcement engine by:
extracting a context associated with the data request;
retrieving a corresponding data policy having a predetermined version from the artifact repository that corresponds to the extracted context;
executing the corresponding data policy on the data request via an open policy agent (OPA) validator application;
framing a data policy evaluation result associated with the corresponding data policy and framing a corresponding validation message; and
returning the data policy evaluation result to a caller application.

20. The non-transitory computer readable storage medium of claim 16, wherein the executable code further causes the processor to develop the data policy by:
performing at least one of creating a new data policy and updating the current data policy that results in an updated data policy;
performing a unit test that comprises testing a functional unit of code correlating to the at least one from among the new data policy and the updated data policy;
performing the impact analysis process on a boundary graph;
publishing a report on the impact analysis process;
evaluating the unit test and the report;
determining whether to approve a change in the current data policy with at least one from among the new data policy and the updated data policy;
building the at least one from among the new data policy and the updated data policy via a build application upon the determining to approve the change that results in a built policy; and
publishing the built policy with a corresponding policy set version for storage in the artifact repository.
